(19) United States
(12) Patent Application Publication
(10) Pub. No.: US 2009/0304240 A1
(43) Pub. Date: Dec. 10, 2009

(54) Notary enforcement - fraud prevention

(76) Inventor: Jeffrey Alan Simonian, Huntington Beach, CA (US)

Correspondence Address: THE PATEL LAW FIRM, P.C., 2532 DUPONT DRIVE, IRVINE, CA, 92612, US

(21) Appl. No.: 12/156,921

(22) Filed: Jun. 5, 2008

(51) Int. Cl. G06K 9/00

(52) U.S. Cl. 382/124

(57) ABSTRACT

A system for electronically capturing and recording the signature and identity of a Signor of a legal document includes an electronic pen for capturing the strokes of the signors signature and is communicatively connected to a computer. A fingerprint scanner is also communicatively connected to the computer for capturing the signor's fingerprint. The computer includes a feature identifier in communication with the fingerprint scanner to identify a plurality of fingerprint features of a scanned fingerprint. A converter converts the scanned fingerprint features into an electronic file for storage in the computer.

### CROSS REFERENCE TO RELATED APPLICATIONS

This utility patent application claims the priority benefit of U.S. provisional patent application entitled “NOTARY ENFORCEMENT—ELECTRONIC SIGNING, VIDEO WITNESSING AND BIO-METRIC PRINT RECORDING ELECTRONICALLY AND STORING TO PREVENT FRAUD AND FORGERY” by the same inventor, filed Jun. 8, 2007, Ser. No. 60/933,756, which is incorporated herein in its entirety by reference as if set forth in full below.

### BACKGROUND OF THE INVENTION

1. Field of the Invention

This invention generally relates to electronic signatures and, more particularly, to an electronic writing instrument having a fingerprint or thumbprint scanner, video conferencing and storage of the witnessing of the signature. This invention will document and provide evidence of the signors' identity and electronic storage of the fingerprint or thumbprint, the signature electronic, scanned or otherwise and the video conferencing of witnessing of the signing of the signors'.

2. Discussion of the Related Art

While notary publics have been verifying and validating identities for decades, fraud and forgeries continue to be problematic in the legal signing and witnessing of legal documents including but not limited to real estate. Enterprises, law enforcement and judicial courts are challenged by evidence and corroboration relating to identity theft, miss-use and forgery.

Enterprises have been moving from paper-based systems to more economical paperless environments, new barriers are presented that must be overcome with new technology. Business transactions, agreements, real estate transactions, validation and authorizations are some examples of events that require one or more person's assent, evidenced by that person's signature, that must be electronically perpetuated in a paperless system. Perpetuation is required to maintain the commercial quality or permanence that is required to support audit, evidentiary and enforcement requirements.

In October 2000, the federal Electronic Signatures in Global and National Commerce Act) also known as “E-Sign”) was signed into law. That new law broadly authorizes electronic records and electronic signatures as being legally effective. The existence of this new law makes real estate and business transactions conducted electronically easier to procure. Therefore, a major barrier for conducting electronic business transactions has been the evidence of signing, witnessing, notorizing of the signature(s). Greater proliferation of electronic business transactions will no doubt be seen in the market place. And with that, a greater sophistication of fraud and forgery has exponentially grown with it.

Typically, electronic signatures are applied to electronic documents within a user's computer. After the electronic signature is appended to an electronic document, the electronic document is electronically transmitted to another computer, where the electronic document may be processed further or stored.

While many solutions have been found to store and process electronic documents with electronic signatures, problems still exist because many real estate and business transactions, although conducted electronically, still require a user to physically affix a user signature to a document, either an electronic document or a paper document. Translating a physical signature into an electronic signature and incorporating uniquely identifying features into the physical signature so it can be used to verify documents presents new problems to overcome.

More importantly the identity of the signor(s) is monumentally important and the integrity of the signing must be procured in order to validate the document and the legal effect. Especially legal real estate documents that are routinely signed, witnessed and notarized.

Providing law enforcement, judicial courts and the investigative arm of the U.S. Department of Justice will benefit tremendously as will lending mortgage institutions, insuring enterprises whether private or government backed. And the losses financially sustained will be reduced exponentially.

### BRIEF DESCRIPTION OF THE DRAWINGS

For a fuller understanding of the nature of the present invention, reference should be made to the accompanying drawings in which:

FIG. 1 is a process flow diagram of the electronic capture and transmittal of a signature and fingerprint;

FIG. 2 is a block schematic of an electronic signature and fingerprint capturing system according to the present invention.

### DETAILED DESCRIPTION OF THE PREFERRED EMBODIMENT

For purposes of description herein, one will understand that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific quantifications and other physical characteristics relating to the embodiments disclosed herein are not to be considered as limiting, unless the claims expressly state otherwise.

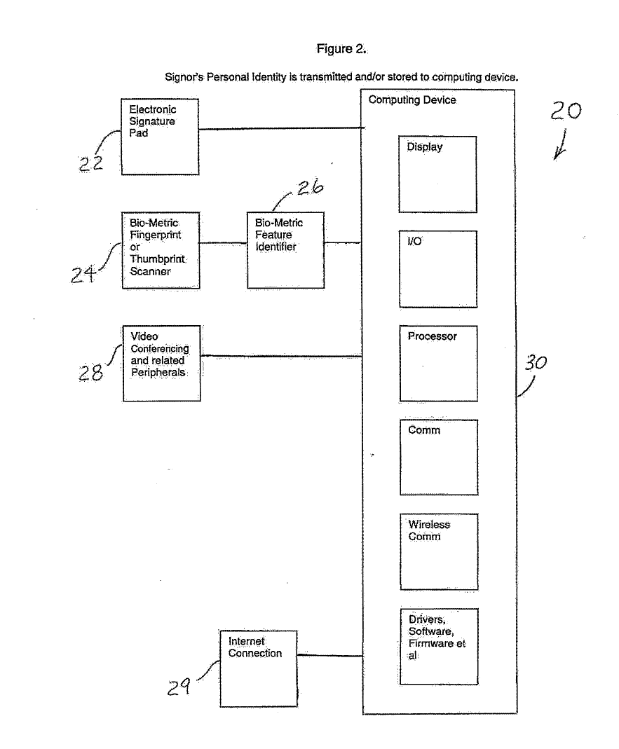

Referring to FIG. 2, a system 20 for electronically capturing and recording the signature and identity of a Signor of a legal document is illustrated in block diagrammatic form. An electronic signature and writing instrument 22, an electronic finger or thumb pad 24 and web based, computing device 30 such as a personal computer, includes electronic random only memory, electronic random access memory (i.e. eprom, rom, ram, cd, dvd et al) software and camera, web cam, lens and similar hardware and related peripherals 28 for the purpose of video conferencing. Computer 30 also has an Internet Connection 29. Combining all three or two of the three or one of these three systems or methods used to record and document the signing of legal documents including, but not limited to real estate documents, deeds of trust, deeds, mortgage loan documents, et al any and all legal documents whereby it is necessary to provide proof of identity and evidence thereof. When combined with the electronic signature instrument (not shown), computer 30, pad 22, writing device and in conjunction with a bio-metric fingerprinting device 24 and video conferencing equipment 28 for recording, saving, storing and otherwise establishing a after the fact storage of data of personal identity of the signor or signors used as validation and/or enforcement of proof of identity and the witnessing of the signing. The fingerprinting device 24 also interfaces with a biometric feature identifier 26 for transforming the fingerprint into a plurality of electronic fingerprint features of the signor's scanned fingerprint for storage in the computer 30.

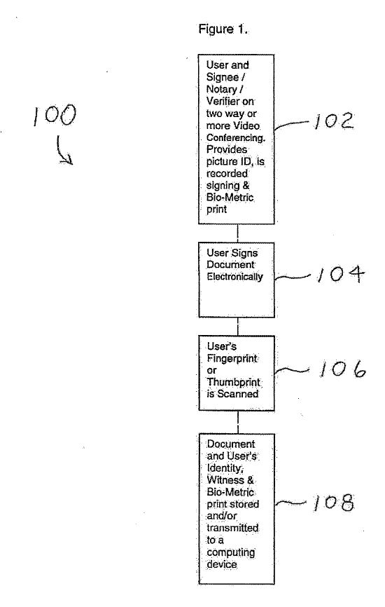

Referring now to FIG. 1, a process 100 for using system 20 is shown wherein the parties such as a signee, notary, and verifier are connected using video conference equipment 28 to verify the parties' identifications in block 102. The user electronically signs the document in block 104. In block 106 the user's finger or thumb rests on the finger pad in such a way that a fingerprint or thumbprint of the user's finger or thumb can be scanned by a fingerprint or thumbprint scanner 24 located in the instrument to obtain fingerprint data. In block 108 the fingerprint data is transmitted to a computing device 30 where the fingerprint data is stored electronically or transmitted through the internet or other transmitting process/system to a storage device or devices, machines, servers, computers et al. The transmission may be through a wired or wireless link. The electronic signature may then be affixed to an electronic document to verify that the user signed the document. The video conferencing of the witnessing of the signature and validation of picture identification and the fingerprint or thumbprint are all stored and may or may not be encrypted. This is very much like but not limited to electronically witnessing, storing and archiving the signing as is traditionally done by notary publics and/or other validating individuals, agencies, systems and/or processes.

Systems and methods are described herein for scanning a fingerprint or thumbprint to use in uniquely identifying an individual's identity in addition an electronic writing instrument for the use and storage of electronic signatures. As well as a video conferencing system providing the evidence and witnessing of the signature, the storage of that video evidence and proof of the identity of the signor. The storage of data may or may not be encrypted but most certainly providing evidence of the individual's identity. Not unlike a traditional notary public today in paper form provides as proof and witness.

The Signor or signors provide their respective picture identification while the video conferencing system is recording jointly while the electronic document is being displayed on the computer system screen (split picture in picture). The electronic signature is stored and may or may not be encrypted and embedded into the legal document, but most certainly electronically stored. The bio-metric fingerprint or thumbprint is also stored and may or may not be encrypted and may or may not be embedded within the body of the document but most certainly is electronically stored.

Providing the archiving of the data may or may not be a part of this system and method.

Once an individual's bio-metric print is used it may or may not be used to auto-populate signatures in the future after the first signature is accepted and never challenged legally.

1. An electronic signing and/or writing instrument, comprising:
a computer;
a pad;
a pen for electronic signatures and communicatively connected to the computer;
a nib located at an end of the pen for applying writing strokes on a surface;
a finger pad on which a fingerprint or thumbprint of a user's finger or thumb rests when the user is validating bio-metric prints;
a fingerprint or thumbprint scanner communicatively connected to the computer and configured to scan the user's fingerprint or thumbprint when the user's finger or thumb is resting on the electronic fingerprint or thumbprint pad;
a feature identifier associated with the computer and in communication with the fingerprint or thumbprint scanner and configured to identify a plurality of fingerprint or thumbprint features of the user's fingerprint or thumbprint scanned by the fingerprint or thumbprint scanner; and
a converter associated with the computer and in communication with the feature identifier and configured to convert fingerprint or thumbprint features identified by the fingerprint scanner and stored with or without encryption.
